(19) United States
(12) Patent Application Publication
(10) Pub. No.: US 2018/0137503 A1
(43) Pub. Date: May 17, 2018

(54) REGISTRATION-BASED USER-INTERFACE ARCHITECTURE

(71) Applicant: Wal-Mart Stores, Inc., Bentonville, AR (US)

(72) Inventors: Donald R. High, Noel, MO (US); Michael D. Atchley, Springdale, AR (US); Chandrashekar Natarajan, Valencia, CA (US)

(21) Appl. No.: 15/814,762

(22) Filed: Nov. 16, 2017

Related U.S. Application Data
(60) Provisional application No. 62/423,006, filed on Nov. 16, 2016.

(51) Int. Cl. G06Q 20/38; G06Q 30/06; G06Q 20/40

(52) U.S. Cl. CPC G06Q 20/389; G06Q 30/0609; H04L 2209/56; G06Q 20/401; G06Q 30/0641

(57) ABSTRACT

A registration-based user-interface architecture includes a retail shopping facility operated on behalf of an enterprise having a plurality of physically-discrete items disposed therein that are offered for retail sale. A control circuit maintains a record (for example, in a blockchain ledger) of a particular customer's purchase of a particular one of these items and also provides an opportunity to that particular customer to resell that particular item via a sales platform operated on behalf of the enterprise. By one approach the control circuit is further configured to interface with the particular customer to register that customer's purchase of this particular item. That interface may be conducted, for example, via a point-of-sale interface, a browser-based interface, a mobile device app-based interface, and so forth. By one approach this registration must necessarily occur within a predetermined amount of time from when the customer purchases the item.

### CROSS-REFERENCE TO RELATED APPLICATION

This application claims the benefit of U.S. Provisional Application No. 62/423,006, filed Nov. 16, 2016, and is incorporated herein by reference in its entirety.

### TECHNICAL FIELD

These teachings relate generally to user interfaces.

### BACKGROUND

In a modern retail store environment, there is a need to improve the customer experience and/or convenience for the customer. With increasing competition from non-traditional shopping mechanisms, such as online shopping provided by e-commerce merchants and alternative store formats, it can be important for “bricks and mortar” retailers to focus on improving the overall customer experience and/or convenience.

Not all customers are necessarily interested in possessing a purchased item for the entire useful life of that item. For example, a customer may purchase a particular item that is required for a particular activity or chore and the customer does not expect to have subsequent need of the item following completion of the corresponding activity. In other cases, a customer who purchases an item can later develop a wish to resell the item for any of a variety of reasons.

Generally speaking, such customers are left to their own devices to arrange for a subsequent resale of their purchased items. Many persons feel unduly challenged or unduly burdened by the requirements that often attend a successful resale of their items.

### BRIEF DESCRIPTION OF THE DRAWINGS

The above needs are at least partially met through provision of the registration-based user-interface architecture described in the following detailed description, particularly when studied in conjunction with the drawings, wherein:

FIG. 1 comprises a block diagram as configured in accordance with various embodiments of these teachings; and

FIG. 2 comprises a flow diagram as configured in accordance with various embodiments of these teachings;

FIG. 3 comprises a flow diagram as configured in accordance with various embodiments of these teachings;

FIG. 4 comprises an illustration of blocks as configured in accordance with various embodiments of these teachings;

FIG. 5 comprises an illustration of transactions configured in accordance with various embodiments of these teachings;

FIG. 6 comprises a flow diagram in accordance with various embodiments of these teachings;

FIG. 7 comprises a process diagram as configured in accordance with various embodiments of these teachings;

FIG. 8 comprises an illustration of a delivery record configured in accordance with various embodiments of these teachings; and

FIG. 9 comprise a system diagram configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a retail shopping facility operated on behalf of an enterprise has a plurality of physically-discrete items disposed therein. In a typical application settings these items are offered for retail sale. A control circuit maintains a record of a particular customer's purchase of a particular one of these items and also provides an opportunity to that particular customer to resell that particular item via a sales platform operated on behalf of the enterprise. By one approach the control maintains this record in a blockchain ledger.

By one approach the control circuit is further configured to interface with the particular customer to register that customer's purchase of this particular item. That interface may be conducted, for example, via a point-of-sale interface, a browser-based interface, a mobile device app-based interface, and so forth. By one approach this registration must necessarily occur within a predetermined amount of time from when the customer purchases the item.

The aforementioned opportunity to resell the item can include an opportunity for the customer to specify a resale price for the item and/or to elect to offer the item for sale via an auction.

By one approach the control circuit is further configured to access previously-stored information regarding the item and to use that information to prepare an offer to resell the item via the aforementioned sales platform. Examples of useful information include but are not limited to textual information that describes the item, reviews of the particular item, and visual representations of the item. By one approach the control circuit accesses that information by accessing the aforementioned blockchain ledger.

These teachings are highly flexible in practice and will accommodate various modifications and/or supplemental features. By one approach, for example, the enterprise may also operate a server-based platform that provides an on-line browser-based opportunity to purchase items, in which case the control circuit can be further configured to maintain a record of purchases made via that on-line browser-based opportunity and to similarly offer an opportunity to such purchasers to resell such items via the aforementioned sales platform. As another example, these teachings will accommodate having the aforementioned enterprise support shipment of items that are resold via the aforementioned sales platform.

So configured, a customer of a physical retail shopping facility can receive additional support to greatly ease and facilitate their later reselling of items they purchase at the retail shopping facility. In particular, such customers have access to a sales platform operated by the corresponding enterprise that may have considerable breadth and depth as regards potential purchasers. In addition, such customers will have ready access to informative, reliable, and likely persuasive content regarding the items they seek to resell, thus saving themselves time and effort while also having the peace of mind that the item is being fairly and accurately represented. The customer receives such benefits while avoiding considerable effort or attention.

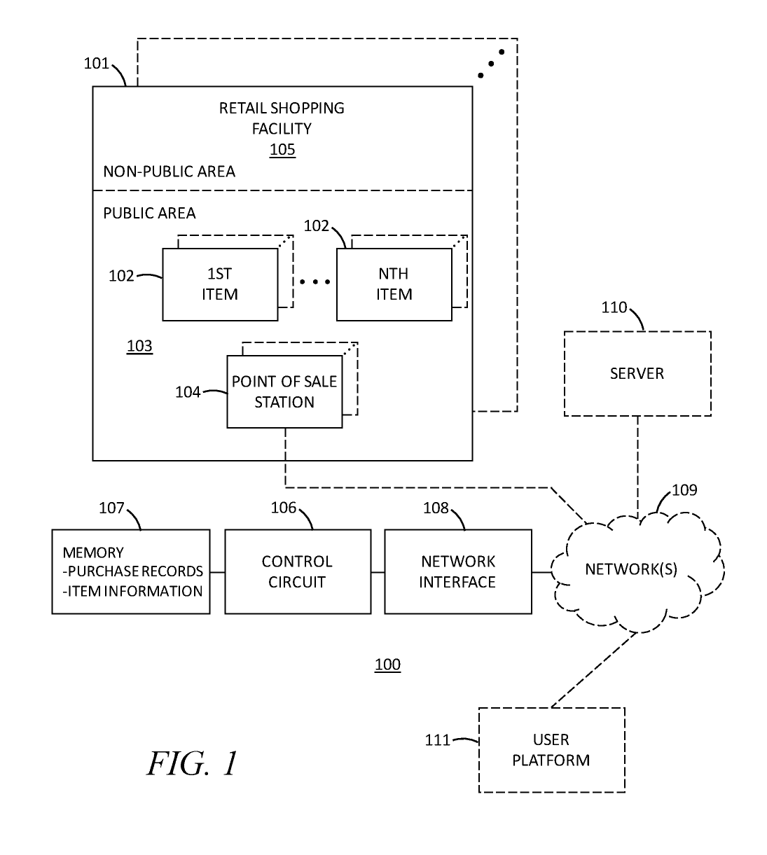

These and other benefits may become clearer upon making a thorough review and study of the following detailed description. Referring now to the drawings, and in particular to FIG. 1, an illustrative apparatus 100 that is compatible with many of these teachings will now be presented.

In this illustrative example the enabling apparatus 100 includes at least one retail shopping facility 101 that is operated on behalf of an enterprise such as an incorporated entity, a legal partnership, a sole proprietorship entity, and so forth. In many application settings the apparatus 100 in fact includes a plurality of such retail shopping facilities 101.

Each retail shopping facility 101 comprises a retail sales facility or any other type of bricks-and-mortar (i.e., physical) facility in which a plurality of items 102 (represented here as a first item through an Nth item, where “N” represents an integer greater than 1) are physically displayed in a public area 103 of the retail shopping facility 101 and offered for sale to customers who physically visit the facility. The shopping facility may include one or more of sales floor areas, checkout locations (i.e., point of sale (POS) stations 104), customer service areas other than checkout locations (such as service areas to handle returns), parking locations, entrance and exit areas, non-public areas 105 such as stock room areas and stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

In this particular example, the enabling apparatus 100 further includes a control circuit 106. Being a “circuit,” the control circuit 106 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 106 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 106 is configured (for example, by using corresponding programming as will be well understood by those skilled in the art) to carry out one or more of the steps, actions, and/or functions described herein.

By one optional approach the control circuit 106 operably couples to a memory 107. This memory 107 may be integral to the control circuit 106 or can be physically discrete (in whole or in part) from the control circuit 106 as desired. This memory 107 can also be local with respect to the control circuit 106 (where, for example, both share a common circuit board, chassis, power supply, and/or housing) or can be partially or wholly remote with respect to the control circuit 106 (where, for example, the memory 107 is physically located in another facility, metropolitan area, or even country as compared to the control circuit 106).

This memory 107 can serve, for example, to non-transitorily store the computer instructions that, when executed by the control circuit 106, cause the control circuit 106 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

By one approach this memory 107 can also serve to store purchase records and/or item information as described herein.

In this example the control circuit 106 also operably couples to a network interface 108. So configured the control circuit 106 can communicate with other elements (both within the architecture of the apparatus 200 and external thereto) via the network interface 108. Network interfaces, including both wireless and non-wireless platforms, are well understood in the art and require no particular elaboration here. To facilitate such communications the network interface 108 can operably couple to one or more networks including but not limited to the Internet (that is, the well-known global system of interconnected computer networks that use the Internet protocol suite (TCP/IP) to link devices worldwide).

By one optional approach the apparatus 100 can further include a computer server 110 that functions as a server-based platform configured to provide an on-line browser-based opportunity to purchase one or more physically-discrete items 102 via that on-line modality. In this illustrative example this server-based platform is also operated on behalf of the same enterprise that operates the above-described retail shopping facility 101. That said, the items 100 to be offered for sale via the server-based platform may be the same, in whole or in part, as the items that are offered for sale at the retail shopping facility 101, or may differ as desired.

So configured, a user platform 111 of choice (such as but not limited to a desktop computer, a mobile device such as a pad/tablet-styled computer or a so-called smart phone, and so forth) can communicate (via, for example, the aforementioned network(s) 109) with the aforementioned server 110 and/or the aforementioned control circuit 106 as described herein or as is otherwise appropriate.

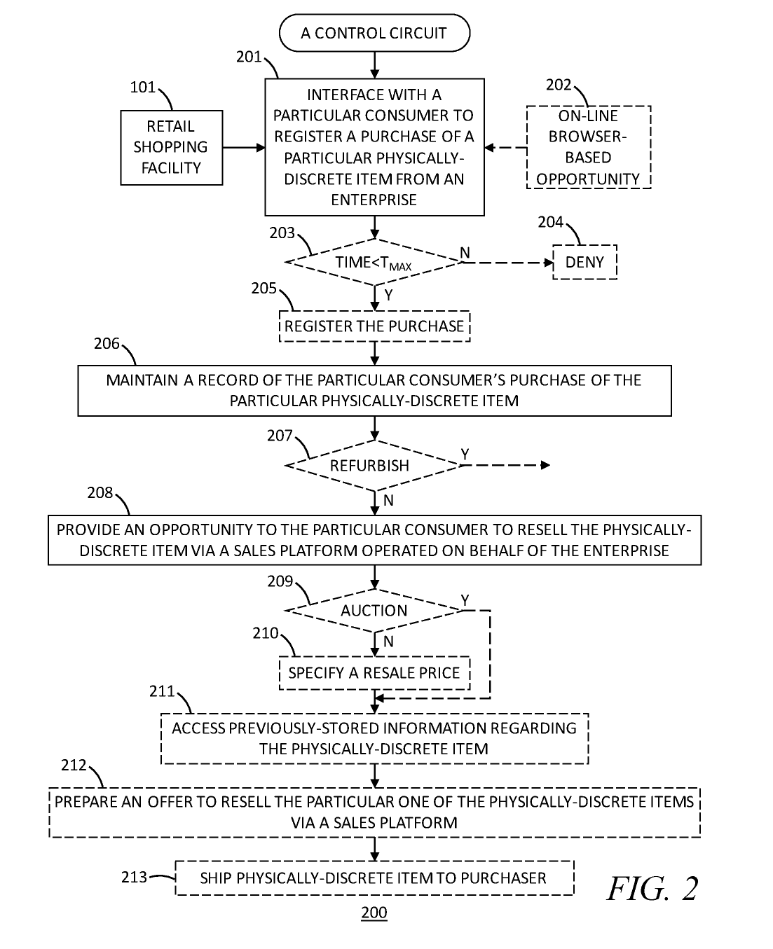

Referring now to both FIGS. 1 and 2, the aforementioned control circuit 106 can be configured to carry out, in whole or in part, the illustrated process 200.

At block 201, the control circuit 106 interfaces with a particular consumer to register that consumer's purchase of a particular one of the aforementioned physically-discrete items 102. (If desired, these teachings will also accommodate registering a consumer's purchase of an item via the aforementioned server-based platform.) In a typical application setting, this activity occurs commensurate with or following the consumer's purchase of that item 102.

These teachings will accommodate facilitating this interface in a variety of ways. By one approach, for example, this interface occurs while the consumer is at the retail shopping facility 101 (for example, via an appropriate point-of-sale interface at the aforementioned point-of-sales station 104). By another approach, the control circuit 106 is configured to interface with the consumer via an on-line browser-based opportunity 202 and/or a mobile device app-based interface (sponsored and/or operated by or on behalf of the aforementioned enterprise).

By one approach, the registration opportunity comprises a part of a larger overall function/opportunity. For example, the “Savings Catcher” mobile device app-based opportunity provided by Walmart permits a consumer to scan or otherwise enter an optical code on their receipts in order to have their purchases automatically compared against other competitors in order to receive cash back when a lower price from a competitor is found. In this case, with the customer's permission the customer's app-associated personal information (such as their identity) can be associated with the specific products that were purchased by the customer and stored in the aforementioned memory 107 as a purchase record that simultaneously serves as the aforementioned registration of this particular consumer's purchase of a particular item 102.

By one approach, as illustrated at decision block 203, the control circuit 106 determines whether this registration activity occurs within a predetermined amount of time from when this particular item was purchased by this particular consumer. For example, the registration process may be denied (at block 204) if the enterprise imposes a maximum window of time of, for example, one month and the consumer seeks to effect registration beyond that permitted time window.

In lieu of the foregoing, or presuming that the consumer seeks to the effect the registration within the aforementioned timeframe, at block 205 the control circuit 106 effects registration of this particular consumer's purchase of this particular physically-discrete item 102.

At block 206 and pursuant to the registration activity described herein the control circuit 106 maintains a record of the consumer's purchase of this particular physically-discrete item 102. As suggested above, such purchase records can be stored, if desired, in the aforementioned memory 107.

The above-described activities may take place commensurate with the consumer's purchase of the particular item or within some predetermined period of time thereof. In a typical application setting the aforementioned steps will be completed within a relatively short period of time (such as a few seconds (say, 10 or 30 seconds) or only a few minutes (say, 1 to 5 minutes)). The following actions described in this process 200 can potentially occur immediately upon effecting the aforementioned registration but more typically will likely occur at some later time, such as one month later, one year later, five years later, and so forth.

By one optional approach, and as illustrated at decision block 207, the control circuit 106 can provide an opportunity to the particular consumer to refurbish the purchased/registered item. (As used herein, “refurbish” means to fully or partially restore an item to an original (or better) working order and/or appearance. Refurbishing may, if desired, include replacing or rebuilding one or more components of the item.) This refurbishing service can be undertaken by the aforementioned enterprise or this refurbishing opportunity may comprise instead providing the consumer with one or more references to one or more refurbishing service providers that the enterprise has vetted and/or otherwise certified or approved.

This process 200 will accommodate offering this refurbishing opportunity at essentially any time following the consumer's purchase of the item. With respect to the present teachings, however, this process 200 will also accommodate providing this refurbishing opportunity in conjunction with providing the opportunity to resell the previously-purchased item as described herein. For example, when the reselling opportunity is provided at least in part via a browser-based webpage, that webpage can include the opportunity for the consumer to select the refurbishing service (to thereby permit the consumer to selectively refurbish their presumably used item prior to attempting to resell that item).

In any event, at block 208 this process 200 provides an opportunity to the aforementioned consumer to resell their previously-purchased physically-discrete item via a sales platform that is operated on behalf of the enterprise (as versus, for example, a third-party service such as eBay or Craigslist). By one approach this opportunity is extended via a browser-based and/or mobile device app-based paradigm (such as a website or app that the enterprise generally operates to interact with customers and potential customers on a more general basis (for example, to provide general information about the enterprise, to provide contact information for the enterprise, to provide information regarding locations and hours of operation for the enterprise's retail sales facilities, to offer new items for retail sale, and so forth).

So configured, the consumer can interact and otherwise engage with the reselling opportunity to, for example, identify both themselves and the item that they wish to sell and to provide other pertinent particulars such as their own identifying information, the current aesthetic/operating condition of the item itself, the present geographic location of the item, particular conditions to apply to the reselling of the item, and so forth. By one approach the consumer can be permitted to “search” their own record of purchased items to locate the previously-registered item that they now wish to resell. By another approach the consumer can be permitted to browse and/or sort their own record of purchased items to locate the item of interest.

By one approach, the control circuit 106 can vet the identified consumer to automatically determine whether this consumer should be permitted to avail themselves of the resale opportunity described herein. For example, this consumer may have utilized the enterprise's resale opportunity in the past to sell items that turned out to be broken, damaged, or otherwise impaired without providing a proper disclosure or disclaimer to that effect. As another example the consumer's prior sales may have been characterized by untimely or inaccurate shipping. Based upon such a record, such a customer may be denied the opportunity to make further use of the resale opportunity described herein.

By one approach, and as illustrated at optional block 209, the control circuit 106 can permit the particular consumer to select between specifying a specific resale price (at block 210) and electing to offer the item for sale via an auction. (When offering the auction opportunity, by one approach the consumer can be provided with an opportunity to designate a minimum starting bid and/or a “buy now” purchase price. The consumer can also be extended other options such as designating the duration of the auction window, restrictions or options regarding payment mechanisms and delivery modalities, and so forth.) By one approach the control circuit 106 can provide exemplary or recommended resale prices for the consumer's consideration. The control circuit 106 may have direct access to such information (derived, for example, as an average of other similar items that have been recently sold via this same resale opportunity) or may have indirect access via third-party sources as desired.

By one approach the enterprise can invoke greater control over the pricing of the item to be offered for resale. For example, this process 200 can provide that the control circuit 106 prevents the consumer from establishing a resale price that exceeds the original purchase price for the item (or some intervening discounted price). In that case, this process can provide for storing that original purchase price at the time of effecting the aforementioned registration. As another related example, the enterprise can place general or specific requirements or limitations with respect to the means and/or costs of shipping the item to the resale customer.

At optional block 211 the control circuit 106 can access previously-stored information (from, for example, the aforementioned memory 107) regarding the particular physically-discrete item that the consumer now seeks to resell. Examples of useful information in these regards include textual information describing the item, reviews of the item, and visual representations (including either or both still images and video images) of the item, and so forth. Such information can include depictions of original owner's manuals, assembly instructions, product recall details, and so forth as provided by the original manufacturer. Such information can also include content from product review sources, user testimonials, anecdotal social media reports, news reports, and so forth as desired.

Some of the aforementioned content may be captured by the control circuit 106 at the present time of need. Per this process 200, however, at least some of this information is “previously-stored” in that the information was captured and stored specifically for direct use by the control circuit 106 prior to the present time of need (i.e., prior to when the consumer selected to pursue the above-described resale opportunity).

At optional block 212 the control circuit 106 prepares an offer to resell the particular one of the physically-discrete items 102 via the aforementioned sales platform per the consumer's election and selections. The control circuit 106 can make use of some or all of the information provided by the consumer when electing to use this resale opportunity. The control circuit 106 can also use the aforementioned previously-stored information when preparing this offer.

So configured, and as one example, the control circuit 106 can post the availability of this used item at a primary website for the enterprise, perhaps in conjunction with offerings of the same item in new condition if desired. By another approach, in combination with the foregoing or in lieu thereof, the availability of the used item can be presented in a segregated manner that is distinct from the offering of new items.

By one approach, all information available to the control circuit 106 regarding the item being offered for resale is simultaneously presented via the sales platform. By another approach at least some portions of the available information is not immediately presented but instead must be selected by, for example, a potential customer who peruses a main or initial presentation of the purchase opportunity.

By one approach a customer who purchases the used item makes their payment to the aforementioned enterprise rather than to the consumer who offers the item for resale (with the enterprise then squaring up with the selling party upon concluding the sale). By another approach the customer makes direct payment to the party who offers the item for resale. If desired, a choice in these regards can be presented to the consumer when first offering the opportunity to resell the item.

By one approach the item, upon being purchased, is shipped or otherwise delivered to the purchaser by the consumer who offers the item for resale. By another approach, the consumer with the used item delivers the item to the care and possession of the enterprise (for example, by shipping or by personally delivering the item to a local retail shopping facility 101 as described above). In this case, and per block 213, the enterprise can support shipment of the used item by itself shipping the item to the party who purchases that item via the aforementioned sales platform.

The aforementioned record of a particular consumer's purchase of a particular one of the physically-discrete items, the opportunity to resell the particular one of the physically-discrete items via a sales platform operated on behalf of the enterprise, and/or various particulars regarding the reselling process itself can comprise any of a wide variety of information items. Examples in these regards include, but are not limited, information regarding whether the enterprise allows particular items to be sold via their sales platform (for example, certain items may be prohibited by law in some relevant manner or the enterprise itself may simply decline to resell certain items), information regarding whether a current or predicted demand exists for particular items in used condition, and estimates regarding wholesale and/or retail remaining value for specific items. Other examples in these regards include whether the consumer did, in fact, purchase a particular item per the foregoing requirements and whether the consumer has previously offered a previous item or this particular item for resale via the sales platform operated on behalf of the enterprise.

Yet other examples in these regards can pertain to the reselling process itself and comprise information items such as whether the customer in fact is offering a particular item for resale, whether a third party has placed a bid for the item and/or whether a third-party placed a winning bid (with the winning bid amount to be held in escrow pending physical availability and/or delivery of the item), whether the consumer properly prepared the item for shipment, whether purchase funds were released to the consumer and, conversely, whether purchase funds were returned to the purchaser for failure of a fulfillment requirement, and so forth.

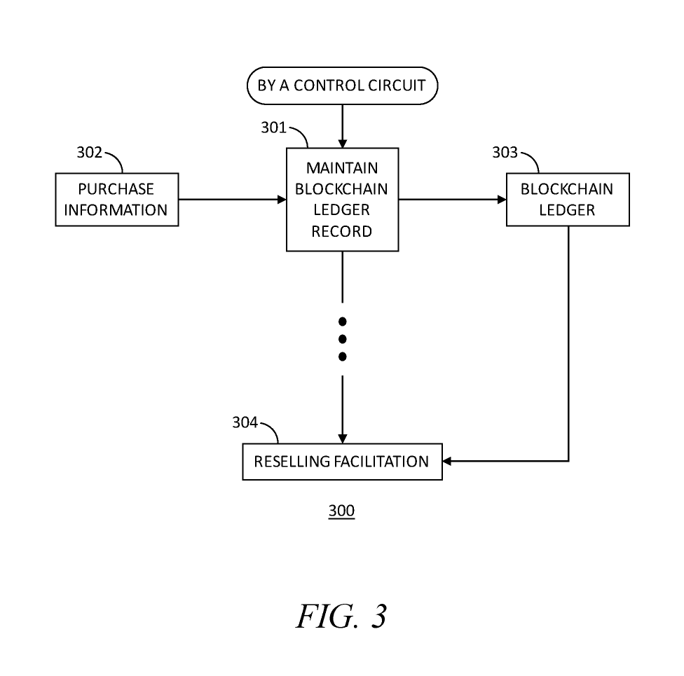

With reference to FIG. 3, some or all of the foregoing items of information can be maintained, if desired, in a blockchain ledger 303 of choice. More particularly, the control circuit 106, at block 301, can maintain a blockchain ledger record to include any one or more of the above-mentioned items of purchase information 302 (including information regarding the specifics of the purchase itself (such as the identity of the purchaser, identifying information for the purchased item, information specific to the purchase transaction itself, supplemental information regarding the purchased item such as advertising or promotional content, professional or consumer reviews, and so forth). This activity can comprise creating one or more blocks of information in one or more public or private blockchain ledgers 303 of choice. At some later point in the time the control circuit 106 can draw upon that record in the blockchain ledger 303 to facilitate the reselling activity described herein.

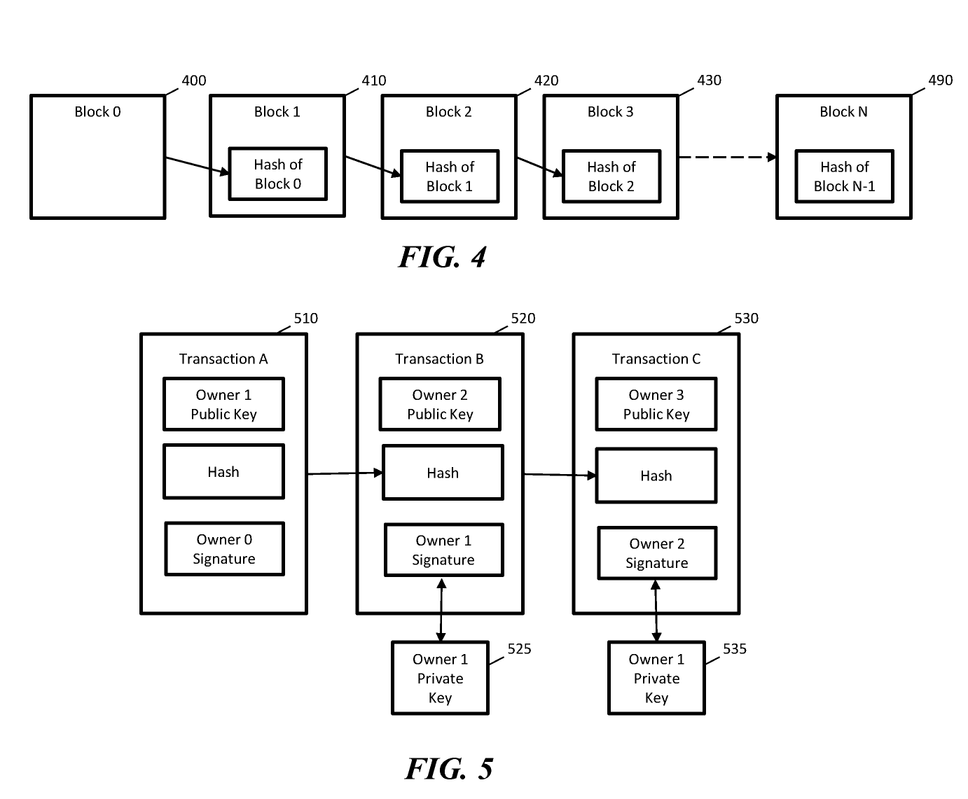

Descriptions of some embodiments of blockchain technology are provided with reference to FIGS. 4-9. A distributed blockchain system will typically constitute a very large number of otherwise unrelated network elements (sometimes referred to as nodes) to store a copy of the blockchain record.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

Generally speaking, a blockchain system can comprise a distributed timestamp server comprising a plurality of nodes configured to generate computational proof of record integrity and the chronological order of its use for content (such as printing instructions), trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash.

In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. (A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference).

Now referring to FIG. 4, an illustration of a blockchain according to some approaches is shown. By one approach, a blockchain comprises a hash chain or a hash tree in which each block added in the chain contains a hash of the previous block. In FIG. 4, block 0 400 represents a genesis block of the chain. Block 1 410 contains a hash of block 0 400, block 2 420 contains a hash of block 1 410, block 3 430 contains a hash of block 2 420, and so forth. Continuing down the chain, block N contains a hash of block N−1.

By one approach, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3.

If desired, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. By one approach, a block may generally contain any type of data and record. Each block may comprise a plurality of transaction and/or activity records.

By one approach, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action (such as a printing action) is authorized. For example, a block may contain a public key of an owner of an asset that allows the owner to show possession and/or transfer the asset using a private key.

Nodes may verify that the owner is in possession of the asset and/or is authorized to transfer the asset based on prior transaction records when a block containing the transaction is being formed and/or verified. By one approach, rules themselves may be stored in the blockchain such that the rules are also resistant to tampering once created and hashed into a block. By one approach, the blockchain system may further include incentive features for nodes that provide resources to form blocks for the chain. For example, in the Bitcoin system, “miners” are nodes that compete to provide proof-of-work to form a new block, and the first successful miner of a new block earns Bitcoin currency in return.

Now referring to FIG. 5, an illustration of blockchain based transactions according to some approaches is shown. By one approach, the blockchain illustrated in FIG. 5 comprises a hash chain protected by private/public key encryption. Transaction A 510 represents a transaction recorded in a block of a blockchain showing that owner 1 (recipient) obtained an asset from owner 0 (sender). Transaction A 510 contains owner's 1 public key and owner 0's signature for the transaction and a hash of a previous block. When owner 1 transfers the asset to owner 2, a block containing transaction B 520 is formed.

The record of transaction B 520 comprises the public key of owner 2 (recipient), a hash of the previous block, and owner 1's signature for the transaction that is signed with the owner 1's private key 525 and verified using owner 1's public key in transaction A 510. When owner 2 transfers the asset to owner 3, a block containing transaction C 530 is formed. The record of transaction C 530 comprises the public key of owner 3 (recipient), a hash of the previous block, and owner 2's signature for the transaction that is signed by owner 2's private key 535 and verified using owner 2's public key from transaction B 220.

By one approach, when each transaction record is created, the system may check previous transaction records and the current owner's private and public key signature to determine whether the transaction is valid. In some embodiments, transactions are broadcast in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending (or using) the asset.

The transactions in FIG. 5 are shown as an example only. By one approach, a blockchain record and/or the software algorithm may comprise any type of rules that regulate who and how the chain may be extended. By one approach, the rules in a blockchain may comprise clauses of a smart contract that is enforced by the peer-to-peer network.

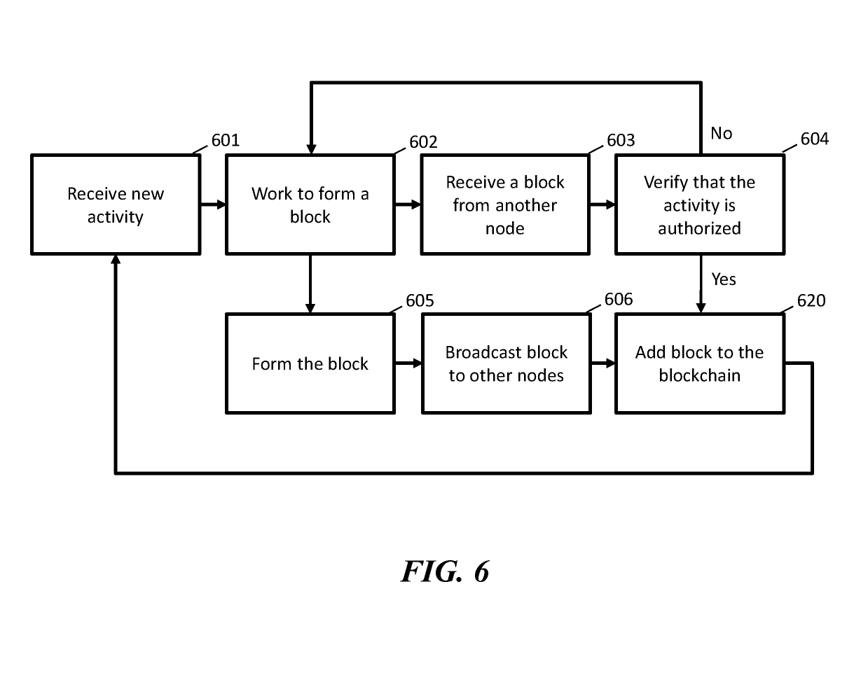

Now referring to FIG. 6, a flow diagram is shown. By one approach, the steps shown in FIG. 6 may be performed by a processor-based device, such as a computer system, a server, a distributed server, a timestamp server, a blockchain node, and the like. By one approach, the steps in FIG. 6 may be performed by one or more of the nodes in a system using blockchain for record keeping.

In step 601, a node receives a new activity. The new activity may comprise an update to the record being kept in the form of a blockchain. By one approach, for blockchain supported digital or physical asset record keeping, the new activity may comprise an asset transaction. By one approach, the new activity may be broadcast to a plurality of nodes on the network prior to step 601.

In step 602, the node works to form a block to update the blockchain. By one approach, a block may comprise a plurality of activities or updates and a hash of one or more previous block in the blockchain. By one approach, the system may comprise consensus rules for individual transactions and/or blocks and the node may work to form a block that conforms to the consensus rules of the system. By one approach, the consensus rules may be specified in the software program running on the node. For example, a node may be required to provide a proof standard (e.g. proof of work, proof of stake, etc.) which requires the node to solve a difficult mathematical problem for form a nonce in order to form a block. By one approach, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. By one approach, in a system with incentive features, the first node to form a block may be permitted to add incentive payment to itself in the newly formed block. In step 620, the node then adds the block to its copy of the blockchain.

In the event that the node receives a block formed by another node in step 603 prior to being able to form the block, the node works to verify that the activity recorded in the received block is authorized in step 604. By one approach, the node may further check the new block against system consensus rules for blocks and activities to verify whether the block is properly formed. If the new block is not authorized, the node may reject the block update and return to step 602 to continue to work to form the block.

If the new block is verified by the node, the node may express its approval by adding the received block to its copy of the blockchain in step 620. After a block is added, the node then returns to step 601 to form the next block using the newly extended blockchain for the hash in the new block.

By one approach, in the event one or more blocks having the same block number is received after step 620, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. By one approach, if a node goes offline for a time period, the node may retrieve the longest chain in the distributed system, verify each new block added since it has been offline, and update its local copy of the blockchain prior to proceeding to step 601.

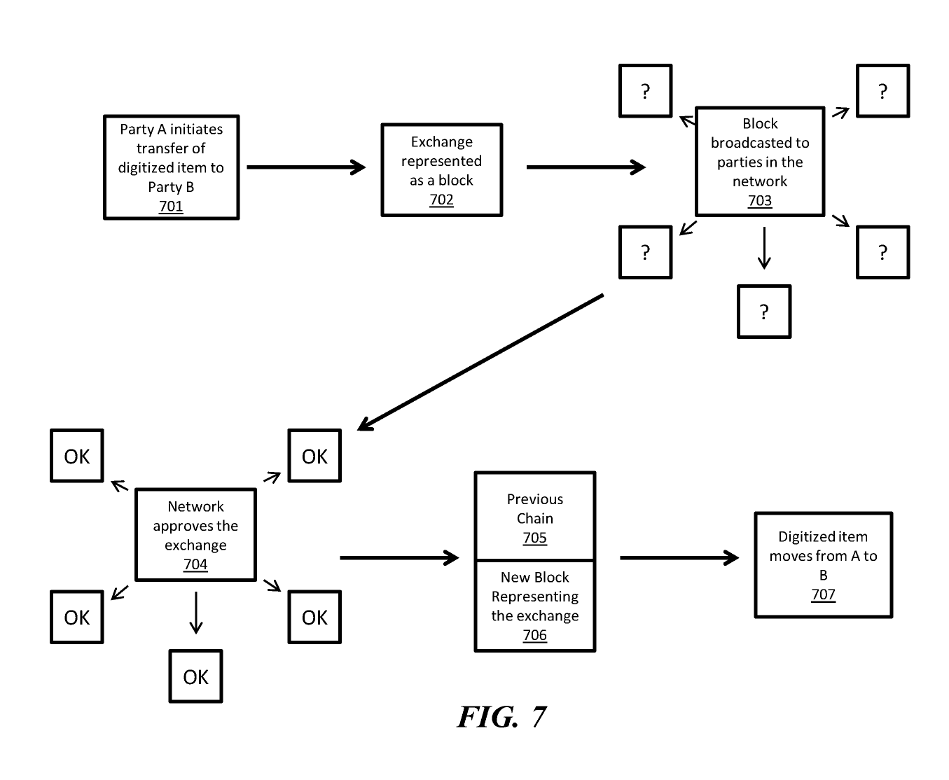

Now referring to FIG. 7, a process diagram illustrates a blockchain update according to some implementations. In step 701, party A initiates the transfer of a digitized item to party B. By one approach, the digitized item may comprise a digital currency, a digital asset, a document, rights to a physical asset, etc. By one approach, Party A may prove that he has possession of the digitized item by signing the transaction with a private key that may be verified with a public key in the previous transaction of the digitized item.

In step 702, the exchange initiated in step 701 is represented as a block. By one approach, the transaction may be compared with transaction records in the longest chain in the distributed system to verify part A's ownership. By one approach, a plurality of nodes in the network may compete to form the block containing the transaction record. By one approach, nodes may be required to satisfy proof-of-work by solving a difficult mathematical problem to form the block. By one approach, other methods of proof such as proof-of-stake, proof-of-space, and so forth may be used in the system. By one approach, the node that is first to form the block may earn a reward for the task as an incentive. For example, in the Bitcoin system, the first node to provide proof of work to for block the may earn a Bitcoin.

By one approach, a block may comprise one or more transactions between different parties that are broadcast to the nodes. In step 703, the block is broadcast to parties in the network. In step 704, nodes in the network approve the exchange by examining the block that contains the exchange. By one approach, the nodes may check the solution provided as proof-of-work to approve the block. By one approach, the nodes may check the transaction against the transaction record in the longest blockchain in the system to verify that the transaction is valid (e.g. party A is in possession of the asset he/she s seeks to transfer). By one approach, a block may be approved with consensus of the nodes in the network.

After a block is approved, the new block 706 representing the exchange is added to the existing chain 705 comprising blocks that chronologically precede the new block 706. The new block 706 may contain the transaction(s) and a hash of one or more blocks in the existing chain 705. By one approach, each node may then update their copy of the blockchain with the new block and continue to work on extending the chain with additional transactions. In step 707, when the chain is updated with the new block, the digitized item is moved from party A to party B.

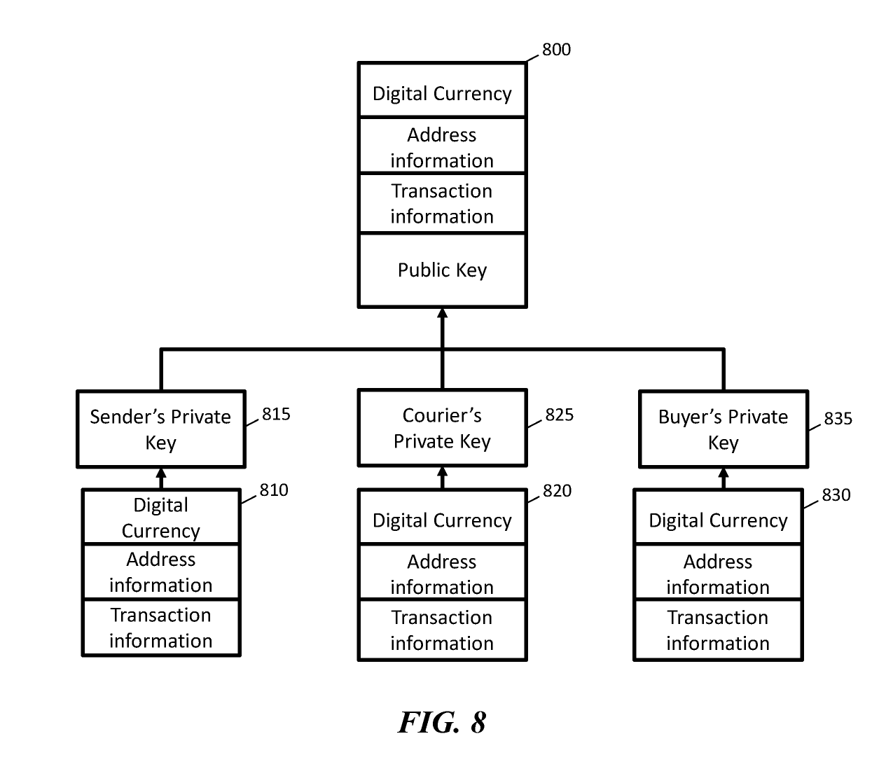

Now referring to FIG. 8, a diagram of an illustrative blockchain is shown. FIG. 8 comprises an example of an implementation of a blockchain system for delivery service record keeping. The delivery record 800 comprises digital currency information, address information, transaction information, and a public key associated with one or more of a sender, a courier, and a buyer.

By one approach, nodes associated the sender, the courier, and the buyer may each store a copy of the delivery record 810, 820, and 830 respectively. By one approach, the delivery record 800 comprises a public key that allows the sender, the courier, and/or the buyer to view and/or update the delivery record 800 using their private keys 815, 825, and the 835 respectively. For example, when a package is transferred from a sender to the courier, the sender may use the sender's private key 815 to authorize the transfer of a digital asset representing the physical asset from the sender to the courier and update the delivery record with the new transaction.

By one approach, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 825 to authorize the transfer of the digital asset representing the physical asset from the courier to the buyer and update the delivery record with the new transaction.

By one approach, the transfer from the courier to the buyer may require signatures from both the courier and the buyer using their respective private keys. The new transaction may be broadcast and verified by the sender, the courier, the buyer, and/or other nodes on the system before being added to the distributed delivery record blockchain.

With the approach shown in FIG. 8, the delivery record may be updated by one or more of the sender, courier, and the buyer to form a record of the transaction without a trusted third party while preventing unauthorized modifications to the record. By one approach, the blockchain based transactions may further function to include transfers of digital currency with the completion of the transfer of the physical asset. With the distributed database and peer-to-peer verification of a blockchain system, the sender, the courier, and the buyer can each have confidence in the authenticity and accuracy of the delivery record stored in the form of a blockchain.

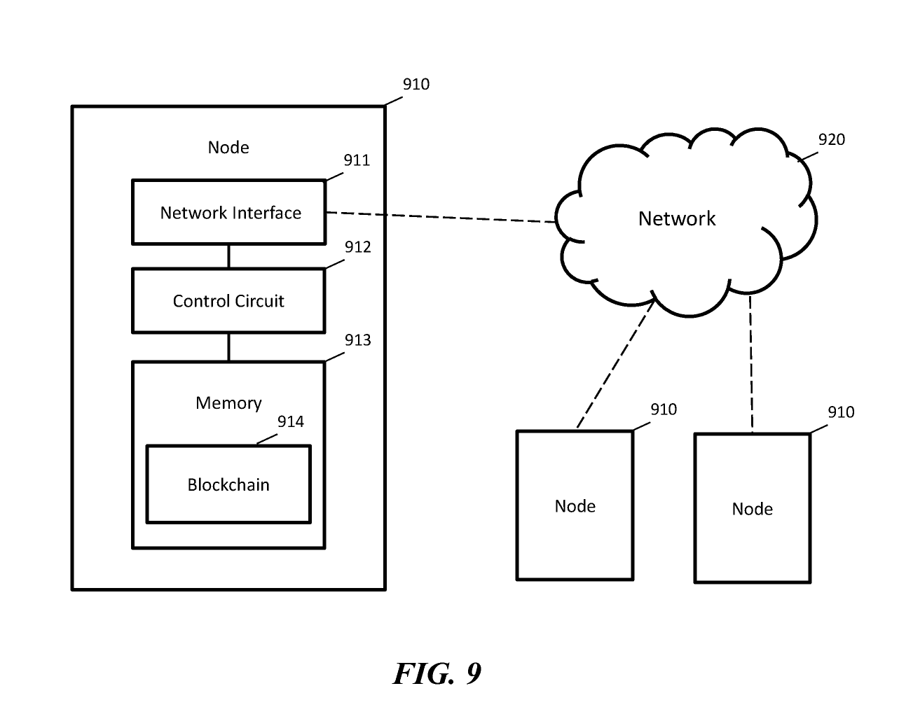

Now referring to FIG. 9, an illustrative distributed blockchain system comprises a plurality of nodes 910 communicating over a network 920. By one approach, the nodes 910 may be comprise a distributed blockchain server and/or a distributed timestamp server. In some embodiments, one or more nodes 910 may comprise or be similar to a “miner” device on the Bitcoin network. Each node 910 in the system comprises a network interface 911, a control circuit 912, and a memory 913.

The control circuit 912 may comprise a processor, a microprocessor, and the like and may be configured to execute computer readable instructions stored on a computer readable storage memory 913. The computer readable storage memory may comprise volatile and/or non-volatile memory and have stored upon it a set of computer readable instructions which, when executed by the control circuit 912, causes the node 910 update the blockchain 914 stored in the memory 913 based on communications with other nodes 910 over the network 920. By one approach, the control circuit 912 may further be configured to extend the blockchain 914 by processing updates to form new blocks for the blockchain 914. Generally, each node may store a version of the blockchain 914, and together, may form a distributed database. By one approach, each node 910 may be configured to perform one or more steps described with reference to FIGS. 6-7 herein.

The network interface 911 may comprise one or more network devices configured to allow the control circuit to receive and transmit information via the network 920. In some embodiments, the network interface 911 may comprise one or more of a network adapter, a modem, a router, a data port, a transceiver, and the like. The network 920 may comprise a communication network configured to allow one or more nodes 910 to exchange data. By one approach, the network 920 may comprise one or more of the Internet, a local area network, a private network, a virtual private network, a home network, a wired network, a wireless network, and the like. By one approach, the system does not include a central server and/or a trusted third party system. Each node in the system may enter and leave the network at any time.

With the system and processes shown in, once a block is formed, the block cannot be changed without redoing the work to satisfy consensus rules thereby securing the block from tampering. An attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

By one approach, a blockchain may be used to secure digital documents such as printing instructions, digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud.

By one approach, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

By one approach, in the peer-to-peer network, the longest chain proves the sequence of events witnessed, proves that it came from the largest pool of processing power and that the integrity of the document has been maintained. By one approach, the network for supporting blockchain based record keeping requires minimal structure. By one approach, messages for updating the record are broadcast on a best-effort basis. Nodes can leave and rejoin the network at will and may be configured to accept the longest proof-of-work chain as proof of what happened while they were away.

By one approach, a blockchain based system allows content use, content exchange, and the use of content for remuneration based on cryptographic proof instead of trust, allowing any two willing parties to employ the content without the need to trust each other and without the need for a trusted third party. By one approach, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, the term blockchain may refer to one or more of a hash chain, a hash tree, a distributed database, and a distributed ledger. In some embodiments, blockchain may further refer to systems that use one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

So configured, these teachings can greatly facilitate the ease by which a purchasing customer can later resell their purchased items. This ease, in turn, can help a potential customer to prefer a particular enterprise when making their initial purchases. These teachings also help ensure fully informing the subsequent follow-upon purchasers as regards the details of the item itself to thereby help ensure a successful resale transaction.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept. As but one illustrative example in these regards, by one approach the enterprise can also provide the consumer who uses the opportunity to resale a previously-purchased item with an opportunity to purchase an extended warranty for the item for the benefit of the eventual purchaser.

What is claimed is:

1. A registration-based user-interface apparatus comprising:
a retail shopping facility operated on behalf of a first enterprise and having a plurality of physically-discrete items disposed therein;
a control circuit configured to:
maintain a record in a blockchain ledger of a particular consumer's purchase of a particular one of the physically-discrete items;
provide an opportunity to the particular consumer to resell the particular one of the physically-discrete items via a sales platform, wherein the opportunity includes leveraging the record in the blockchain ledger.

2. The apparatus of claim 1 wherein the enterprise operates a plurality of retail shopping facilities and wherein the sales platform is configured to offer previously-purchased items from any of the plurality of retail shopping facilities.

3. The apparatus of claim 1 wherein the control circuit is further configured to:
interface with the particular consumer to register the particular consumer's purchase of the particular one of the physically-discrete items as part of the blockchain ledger record.

4. The apparatus of claim 3 wherein the control circuit is configured to interface with the particular consumer to register the particular consumer's purchase of the particular one of the physically-discrete items provided the particular consumer register their purchase within a predetermined amount of time from when the particular one of the physically-discrete items was purchased by the particular consumer.

5. The apparatus of claim 4 wherein the control circuit is configured to so interface with the particular consumer via at least one of:
a point-of-sale interface;
a browser-based interface;
a mobile device app-based interface.

6. The apparatus of claim 1 wherein the sales platform comprises a browser-based platform.

7. The apparatus of claim 1 wherein the sales platform is configured to permit the particular consumer to specify a resale price for the particular one of the physically-discrete items and wherein the resale price is entered into the blockchain ledger.

8. The apparatus of claim 7 wherein the sales platform is configured to permit the particular consumer to select between specifying a resale price for the particular one of the physically-discrete items and electing to offer the particular one of the physically-discrete items for sale via an auction and wherein the selection is entered into the blockchain ledger.

9. The apparatus of claim 1 further comprising:
a server-based platform configured to provide an on-line browser-based opportunity to purchase at least some of the physically-discrete items;
and wherein the control circuit is further configured to:
maintain a record in the blockchain ledger of a second consumer's purchase of a particular one of the physically-discrete items via the on-line browser-based opportunity;
provide an opportunity to the second consumer to resell the particular one of the physically-discrete items that was purchased via the on-line browser-based opportunity via the sales platform, wherein the opportunity includes leveraging the record in the blockchain ledger.

10. The apparatus of claim 1 wherein the control circuit is further configured to:
access previously-stored information in the blockchain ledger regarding the particular one of the physically-discrete items and use that previously-stored information to prepare an offer to resell the particular one of the physically-discrete items via the sales platform.

11. The apparatus of claim 10 wherein the previously-stored information comprises textual information describing the particular one of the physically-discrete items.

12. The apparatus of claim 11 wherein the textual information comprises reviews of the particular one of the physically-discrete items.

13. The apparatus of claim 10 wherein the previously-stored information comprises visual representations of the particular one of the physically-discrete items.

14. The apparatus of claim 1 wherein the control circuit is further configured to:
provide an opportunity to the particular consumer to refurbish the particular one of the physically-discrete items in conjunction with providing the opportunity to resell the particular one of the physically-discrete items.

15. The apparatus of claim 1 wherein the sales platform is configured to support shipment of the particular one of the physically-discrete items by the particular consumer directly to a party who purchases the particular one of the physically-discrete items via the sales platform.

16. The registration-based user-interface apparatus of claim 1 wherein the sales platform is operated on behalf of the first enterprise.
